(19) United States
(12) Patent Application Publication
(10) Pub. No.: US 2018/0109463 A1
(43) Pub. Date: Apr. 19, 2018

(54) Method of dynamically adjusting frame aggregation size

(71) Applicant: MEDIATEK INC., Hsin-Chu (TW)

(72) Inventors: Pei-Hsuan Chiu, Taoyuan City (TW); Tsai-Yuan Hsu, Hsinchu County (TW); Shun-Yong Huang, Hsinchu County (TW); Chih-Wei Kang, Taipei City (TW); Ying-You Lin, Taoyuan City (TW); Hung-Jie Chen, Taichung City (TW)

(21) Appl. No.: 15/723,193

(22) Filed: Oct. 3, 2017

Related U.S. Application Data
(60) Provisional application No. 62/408,073, filed on Oct. 14, 2016.

(51) Int. Cl. H04L 12/805; H04L 12/26; H04L 12/835

(52) U.S. Cl. CPC H04L 47/365; H04L 43/0888; H04W 84/12; H04L 47/30; H04L 43/16

(57) ABSTRACT

The method of dynamically adjusting frame aggregation size for a first communication device receiving aggregation packets from a second communication device in a wireless communication system is disclosed. The method comprises monitoring a buffered data size of the first communication device, and notifying the second communication device of a capable buffer size of the first communication device when the buffered data size monitored by the first communication device is higher than a threshold.

### CROSS REFERENCE TO RELATED APPLICATIONS

This application claims the benefit of U.S. Provisional Application No. 62/408,073, filed on Oct. 14, 2016 and entitled “Channel Utilization Improvement for SU RX and MU RX”, the contents of which are incorporated herein in their entirety.

### BACKGROUND

The IEEE 802.11 standard allows sending multiple frames per single access to the medium by combining the frames together into one larger frame. There are two forms of frame aggregation: Aggregated media access control (MAC) Protocol Data Unit (AMPDU) and Aggregated MAC Service Data Unit (AMPDU).

In addition, the IEEE 802.11 standard introduces the concept of “Block ACK”, which is represented as a single acknowledgement for multiple frames. “Block ACK” along with AMPDU is used in the IEEE 802.11 standard to achieve significant improvement in application throughput. In detail, for AMPDU transmission, a BA session must be setup in each direction (TX device and RX device). The session is setup by using ADDBA request and ADDBA response, and therefore the TX device starts to send AMPDU. On the other hand, DELBA request can be used to release the BA session for AMPDU transmission.

However, due to hardware limitations, i.e. bandwidth, processor power, etc, buffer full event may occur in the RX device when the TX device aggregates too many packets in burst than the RX device could handle. This situation may result in retried packets in the air, which may decrease the channel utilization.

Reference is made to FIG. 1, which illustrates a relation between aggregation size and packet error rate (PER)/first in first out (FIFO) full ratio in single-user (SU) RX scenario. In FIG. 1, PER in TX device and buffer full ratio in RX device are greatly increased with AMPDU aggregation size increasing. For example, the PER is around 1%, 10%, 35%, 56%, 73%, 78% and 85%, and the buffer full ratio is around 1%, 10%, 40%, 60%, 80%, 88% and 92% when the AMPDU size is 16, 24, 32, 40, 48, 56 and 64.

In addition, referring to FIG. 2, which illustrates a relation between aggregation size and PER/FIFO full ratio in multi-user (MU) RX scenario. With similar concept in the FIG. 1, the buffer full ratios in RX devices (e.g. user 0 and user 1 shown in FIG. 2) are increased with the AMPDU size increasing. Besides, the MU RX gain, which means the ratio of total MU RX throughput and total SU RX throughput, is decreased with the AMPDU size increasing.

As abovementioned, with single-user reception, high PER at the TX device side is occurred due to buffer full of the RX device. With multi-user reception, peak throughput of the all MU RX devices may be decreased. As a result, the PER may not reflect actual PER in the corresponding channel condition. Therefore, the channel condition may be good, but the TX device decreases the data transmission rate due to the high PER caused by the buffer full of the RX device.

### SUMMARY

It is therefore an objective to provide a method of dynamically adjusting frame aggregation size, to improve throughput and channel utilization in a wireless communication system.

The present invention discloses a method of dynamically adjusting frame aggregation size for a first communication device receiving aggregation packets from a second communication device in a wireless communication system. The method comprises monitoring a buffered data size of the first communication device itself, and notifying the second communication device of a capable buffer size of the first communication device when the buffered data size monitored by the first communication device is higher than a threshold.

The present invention discloses a method of dynamically adjusting frame aggregation size for a first communication device transmitting aggregation packets to a second communication device in a wireless communication system. The method comprises receiving a notification indicating a capable buffer size of the second communication device, from the second communication device, and decreasing an aggregation packet size for transmitting the aggregation packets to the second communication device according to the capable buffer size in the notification.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a relation between aggregation size and packet error ratio/buffer full ratio in single-user (SU) RX scenario.

FIG. 2 is a schematic diagram of a relation between aggregation size and packet error ratio/buffer full ratio in multi-user (MU) RX scenario.

FIG. 3 is a schematic diagram of an exemplary communication device.

FIG. 4 is a flowchart of an exemplary process according to the present disclosure.

FIGS. 5-6 are schematic diagrams of a dynamically aggregation size adjustment between the RX and TX devices according to the present disclosure.

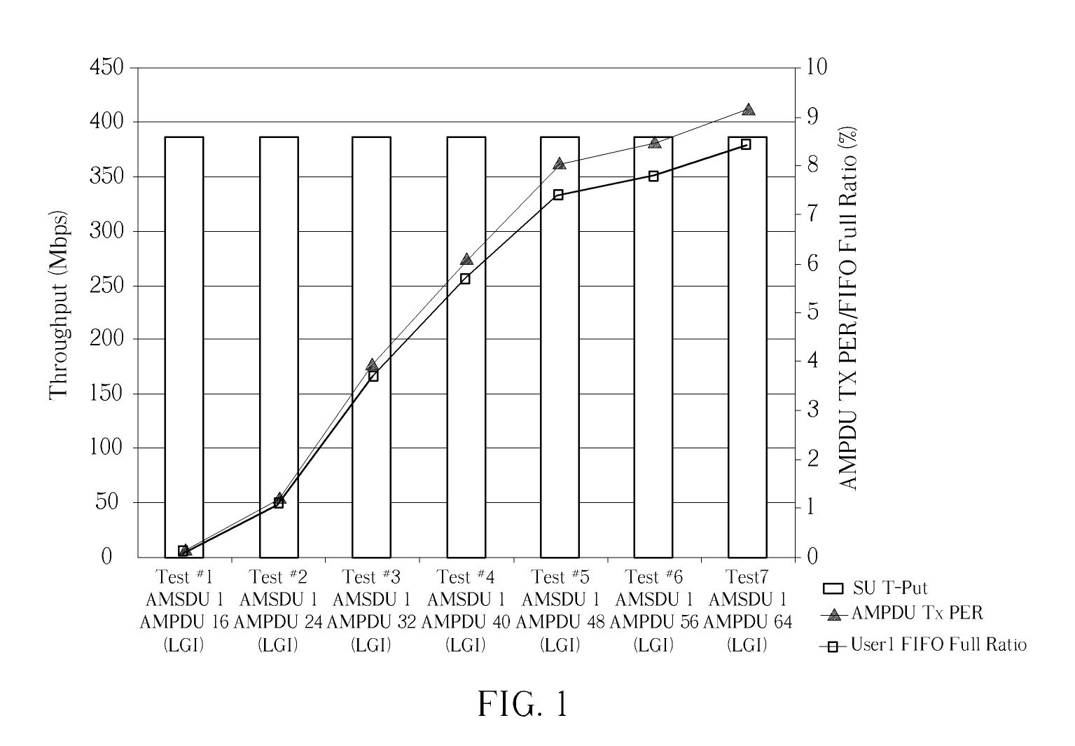

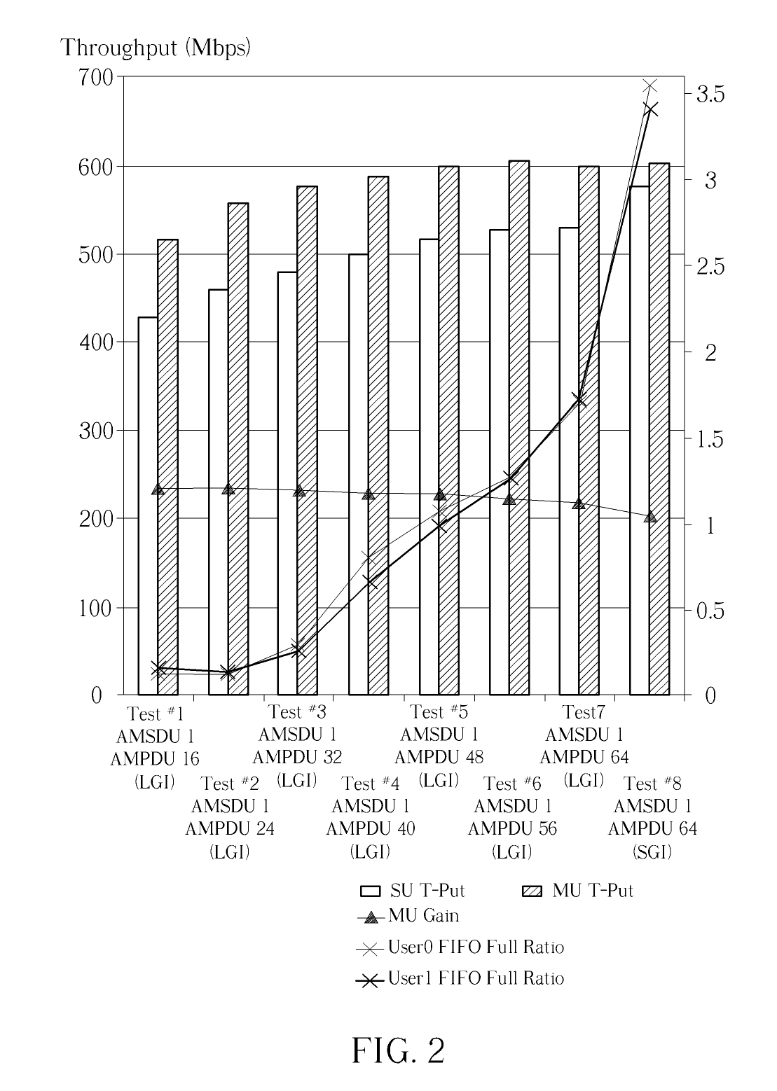

### DETAILED DESCRIPTION

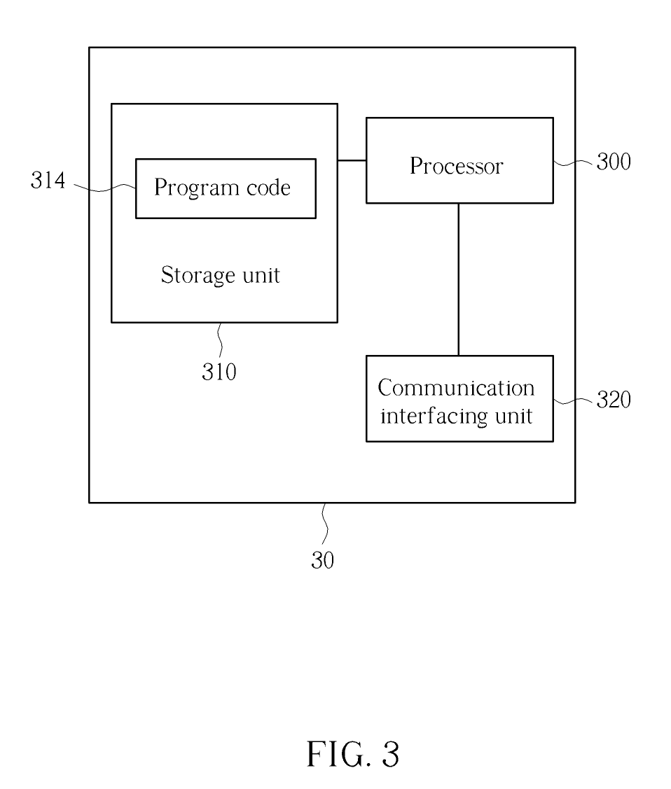

FIG. 3 illustrates a schematic diagram of an exemplary communication device 30. The communication device 30 can be a receiving (RX) device for aggregation packet reception or a transmitting (TX) device for aggregation packet transmission. The device can be devices such as wearable device, appliances, and machine type devices compatible to wireless communication specification. The communication device 30 may include a processor 300 such as a microprocessor or Application Specific Integrated Circuit (ASIC), a storage unit 310 and a communication interfacing unit 320. The storage unit 310 maybe any data storage device that can store program code 314, for access by the processor 300. Examples of the storage unit 310 include but are not limited to a read-only memory (ROM), flash memory, random-access memory (RAM), CD-ROMs, magnetic tape, hard disk, and optical data storage device. The communication interfacing unit 320 is preferably a radio transceiver and can exchange wireless signals according to processing results of the processor 300.

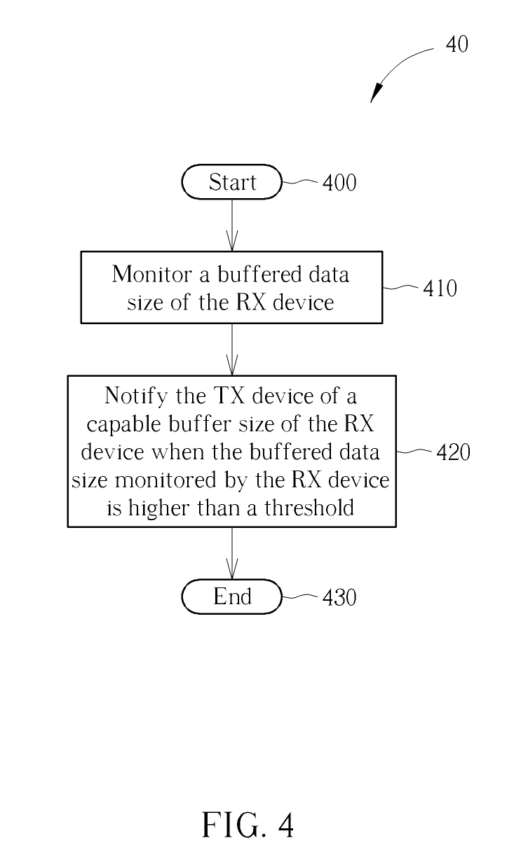

Please refer to FIG. 4, which is a flowchart of a process 40 according to an example of the present disclosure. The process 40 is utilized in the RX device of FIG. 3, for aggregation packet size adjustment. The process 40 may be compiled into a program code 314 to be stored in the storage unit 310, and may include the following steps:

Step 400: Start.

Step 410: Monitor a buffered data size of the RX device.

Step 420: Notify the TX device of a capable buffer size of the RX device when the buffered data size monitored by the RX device is higher than a threshold.

Step 430: End.

According to the process 40, the RX device notifies a newly capable buffer size or supported window size to the TX device when RX device detects that the buffered data size of the RX device is higher than a threshold. Therefore, the TX device may adjust the aggregation packet size for transmission according to the buffer size obtained in the notification, so as to avoid high PER in TX device due to buffer full in the RX device. In other words, instead of decreasing the data transmission rate, the TX device decreases the aggregation packet size (e.g. AMPDU size), and thus the PER may be lower but throughput in the RX device is remained in high.

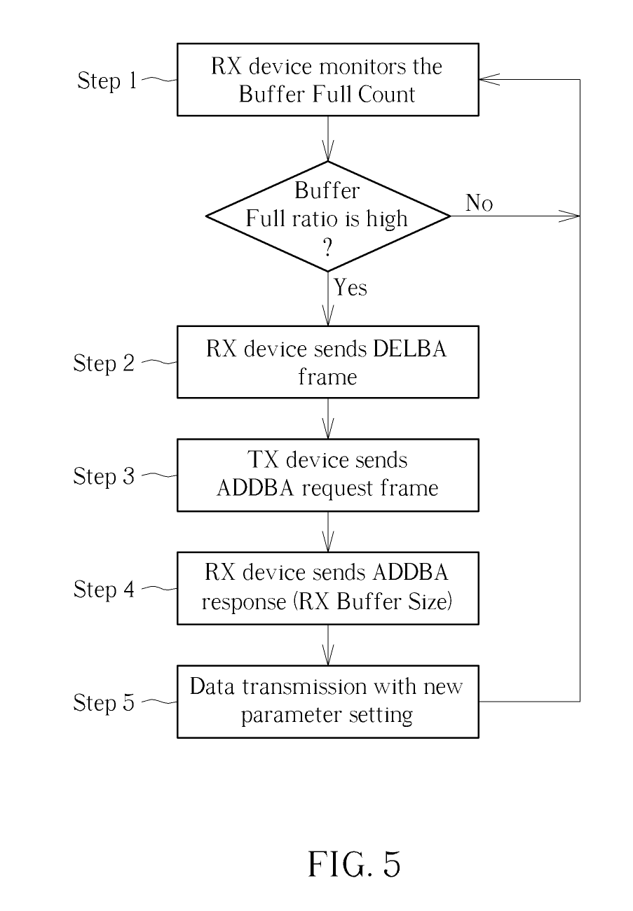

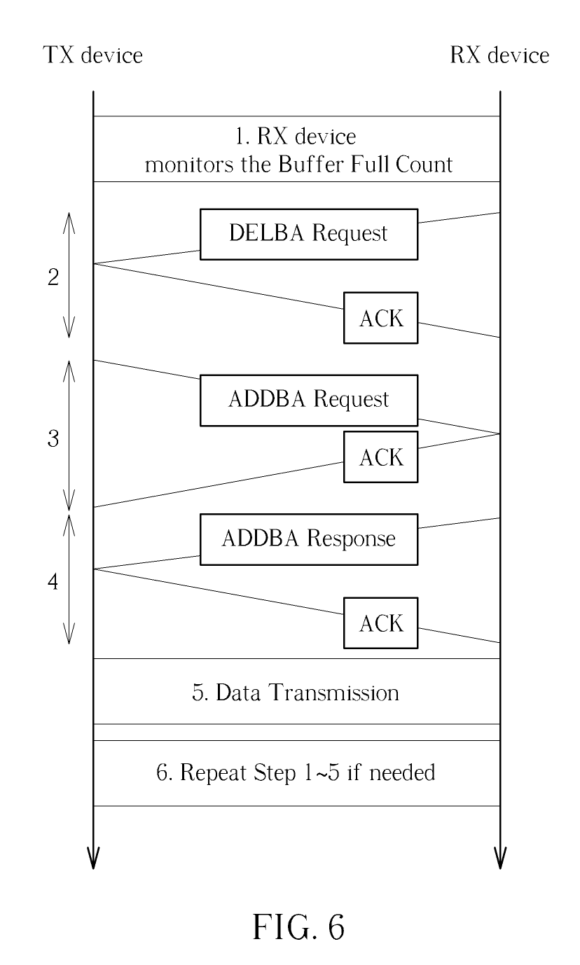

Reference is made to FIGS. 5-6, which illustrate dynamic aggregation size adjustment actions between the RX and TX devices according to the present disclosure. As shown in FIGS. 5-6, the RX device keeps monitoring the buffer full ratio itself (step 1), and sends “DELBA frame” if the buffer full ratio is high (step 2). After receiving the “DELBA frame” from the RX device, the TX device sends “ADDBA request frame” to the RX device (step 3), and thus the RX device sends “ADDBA response frame” to the TX device (step 4). It should be noted that the “ADDBA response frame” includes block ACK parameter set can be used for informing the TX device to adjust AMPDU aggregation size. Then, the TX device performs data transmission with new transmission parameters (i.e. available buffer size of RX device) in the “ADDBA response frame” received from RX device (step 5). In addition, the RX and TX devices may repeat step 1-5 if RX device detects its buffer full ratio is still high (step 6). With smaller AMPDU aggregation size, the PER in the TX maybe decreased, so as to improve the channel utilization.

The abovementioned steps of the processes/operations including suggested steps can be realized by means that could be a hardware, a software, or a firmware known as a combination of a hardware device and computer instructions and data that reside as read-only software on the hardware device or an electronic system. Examples of hardware can include analog, digital and mixed circuits known as microcircuit, microchip, or silicon chip. Examples of the electronic system can include a system on chip (SOC), system in package (SiP), a computer on module (COM) and the communication device 30.

In conclusion, the present invention provides a mechanism by which TX device could retrieve real PER reflecting channel condition and furthermore mitigate RX buffer full occurrence. More specific, with RX device monitoring buffered data size and notifying capable buffer size to the TX device, the TX device can dynamically adjust the aggregation size for transmission, such that channel utilization is improve to reduce retried packets/frames as well as PER in TX device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of dynamically adjusting a frame aggregation size for a first communication device receiving aggregation packets from a second communication device in a wireless communication system, the method comprising:
monitoring a buffered data size of the first communication device; and
notifying the second communication device of a capable buffer size of the first communication device when the buffered data size monitored by the first communication device is higher than a threshold.

2. The method of claim 1, wherein the step of notifying the second communication device of the capable buffer size of the first communication device when the buffered data size monitored by the first communication device is higher than the threshold comprises:
transmitting a ADDBA response including the capable buffer size to the second communication device.

3. The method of claim 2, further comprising:
transmitting a DELBA request to the second communication device for releasing a previously established aggregation packet transmission session; and
receiving a ADDBA request for establishment a new aggregation packet transmission session, from the second communication device.

4. A method of dynamically adjusting a frame aggregation size for a first communication device transmitting aggregation packets to a second communication device in a wireless communication system, the method comprising:
receiving a notification indicating a capable buffer size of the second communication device, from the second communication device; and
decreasing an aggregation packet size for transmitting the aggregation packets to the second communication device according to the capable buffer size in the notification.

5. The method of claim 4, wherein the step of receiving the notification indicating the capable buffer size of the second communication device, from the second communication device comprises:
receiving a ADDBA response including the capable buffer size of the second communication device, from the second communication device.

6. The method of claim 5, further comprising:
receiving a DELBA request for releasing a previously established aggregation packet transmission session, from the second communication device; and
transmitting a ADDBA request for establishment a new aggregation packet transmission session, to the second communication device.
